(19) United States
(12) Patent Application Publication
(10) Pub. No.: US 2006/0014564 A1
(43) Pub. Date: Jan. 19, 2006

(54) External illumination device for a mobile phone

(76) Inventor: Shao-Tsu Kung, Taipei (TW)

Correspondence Address: RABIN & BERDO, P.C.;Suite 500, 1101 14 Street, N.W., Washington, DC, 20005, US

(21) Appl. No.: 10/890,269

(22) Filed: Jul. 14, 2004

(51) Int. Cl. H04M 1/00

(52) U.S. Cl. 455/557; 455/550.1

(57) ABSTRACT

An external illumination device for a mobile phone has an illumination unit and a plug. The external illumination device is connected to the mobile phone by an audio jack or an I/O connector of the mobile phone. The battery of the mobile phone supplies the power required for the external illumination device through the audio jack or the I/O connector. When the illumination unit is a laser diode, the mobile phone is used as a pointer. When the illumination unit is a light emitting diode, the mobile phone is used as an illuminator.

### BACKGROUND

1. Field of Invention

The present invention relates to an external illumination device for a mobile phone. More particularly, the present invention relates to the external illumination device powered by the mobile phone.

2. Description of Related Art

During a meeting or a presentation, the presenter usually needs a pointer to assist the presentation process. In view of this need, a pointer utilizing a light beam for indication has been developed. Generally, the pointer utilizes a laser diode as a light source. The laser diode can generate high intensity, focused light beam for indication. The pointer employing a laser diode is usually powered by a battery.

However, except as a pointer during the presentation, this type of laser diode pointer has no other function in daily life. Therefore, most people are unwilling to spend money on it. Besides, due to the size of the battery, this type of laser diode pointer is usually too bulky to carry easily. The result is that even if the speaker does own a laser diode pointer, the speaker frequently forgets to bring laser diode pointer.

A similar situation occurs when people enter a totally dark environment, such as a parking lot. When people enter an environment without illumination, they usually wish to have a handy illumination device that can provide a temporary light source on the spot. However, it is impossible for people to bring a bulky flashlight with them all the time. Most of the time, people still don't have a handy illumination device and get stuck in a dark environment.

For the forgoing reasons, there is a need for a handy pointer and an illumination device that are easy to carry. Further, both of them can acquire electricity easily from a mobile phone.

### SUMMARY

It is therefore an objective of the present invention to provide an external illumination device, which is connected to a mobile phone via an audio jack and powered by the battery in the mobile phone.

It is another objective of the present invention to provide an external illumination device, which is connected to a mobile phone via an I/O connector and powered by the battery in the mobile phone.

In accordance with the foregoing and other objectives of the present invention, an external illumination device for a mobile phone is proposed. The mobile phone has an audio jack into which the external illumination device connects. The external illumination device includes an illumination unit and a plug. The illumination unit generates light and the plug is plugged into the audio jack of the mobile phone. The external illumination device is powered by the battery in the mobile phone via the audio jack.

In accordance with another objective of the present invention, an external illumination device for a mobile phone is proposed. The mobile phone has an I/O connector where the external illumination device connects. The external illumination device includes an illumination unit and a plug. The illumination unit generates light and the plug is plugged into the I/O connector of the mobile phone. The external illumination device is powered by the battery in the mobile phone via the I/O connector.

The present invention provides an external illumination device for a mobile phone. By connecting the external illumination device to the mobile phone, which most people carry on their person in everyday life, the user can easily obtain a temporary light source or a pointer at anytime.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a side view according to one preferred embodiment of the present invention;

FIG. 2 is block diagram according to one preferred embodiment of the present invention;

FIG. 3 is a side view according to another preferred embodiment of the present invention; and

FIG. 4 is block diagram according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

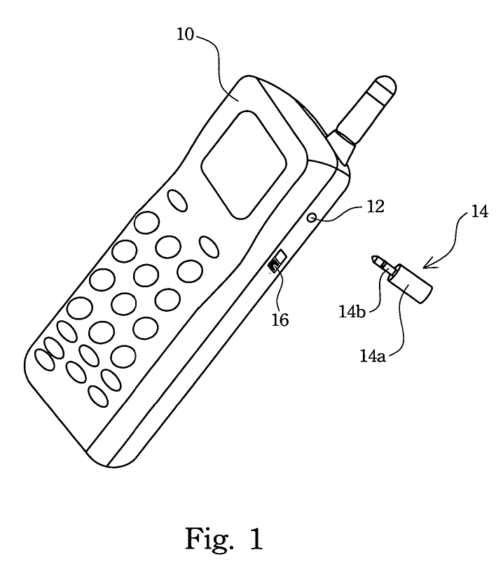

FIG. 1 is a side view according to one preferred embodiment of the present invention. The external illumination device 14 according to one preferred embodiment of the present invention includes an illumination unit 14a and a plug 14b. The plug 14b of the external illumination device 14 is plugged into the audio jack 12 of the mobile phone 10. The external illumination device 14 can be powered by the battery of the mobile phone 14 via the audio jack 12. The illumination unit 14a can be a laser diode lamp for use a pointer for presentation, or a light emitting diode lamp for general illumination purposes.

The external illumination device 14 is activated by the analog switch 16 provided on the mobile phone 10. By switching the analog switch 16 to the V_{bat} state, the electricity in the battery of the mobile phone 10 is supplied to the external illumination device 14.

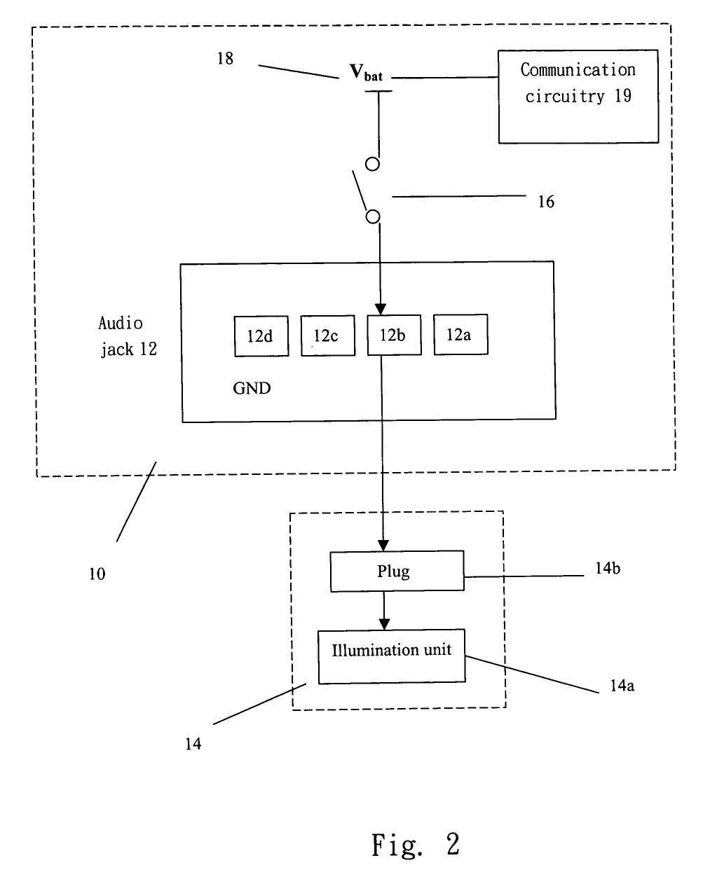

FIG. 2 is a detailed block diagram according to one preferred embodiment of the present invention. The mobile phone 10 has an audio jack 12, an analog switch 16, a battery 18 and communication circuitry 19. The external illumination device 14 includes an illumination unit 14a and a plug 14b. The audio jack 12 has first pin 12a, a second pin 12b, a third pin 12c, and a fourth pin 12d. By plugging the plug 14b into the audio jack 12, the external illumination device 14 is connected to the mobile phone 10.

The battery 18 provides electricity both for the communication circuitry 19 and the illumination device 14. The audio jack 12 is connected in parallel to the communication circuitry 19 and controlled by the analog switch 16. When the analog switch 16 is closed, the battery 18 provides electricity to the external illumination device 14 via the second pin 12b of the audio jack 12.

Further, by programming the circuitry of the mobile phone, the external illumination device can also be activated by the function keys on the mobile phone. For example, by pressing one or several function keys on the mobile phone, the user can directly activate the external illumination device without utilizing the analog switch. This further facilitates the usage of the external illumination device.

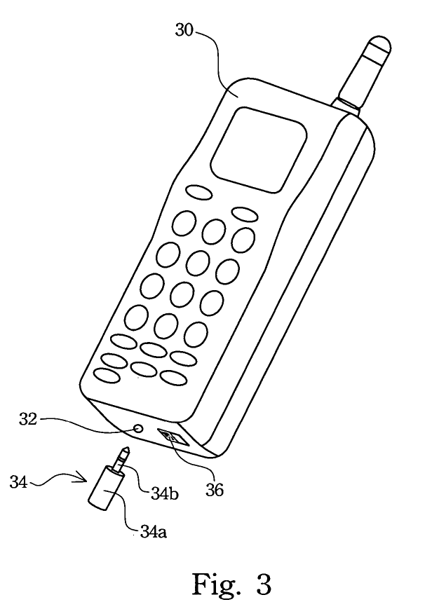

In addition to the audio jack, the I/O connector of the mobile phone can also be employed as the connection between the mobile phone and the illumination device. FIG. 3 illustrates a side view according to another embodiment of the present invention. The external illumination device 34 includes an illumination unit 34a and a plug 34b. The plug 34b of the external illumination device 34 is plugged into the I/O connector 32 of the mobile phone 30. The external illumination device 34 is powered by the battery of the mobile phone 34 via the I/O connector 32. The illumination unit 34a can be a laser diode lamp for a pointer for presentations, or a light emitting diode lamp for general illumination purposes.

The external illumination device 34 can be activated by the analog switch 36 provided on the mobile phone 30. By switching the analog switch 36 to the V_{bat} state, the electricity in the battery of the mobile phone 30 is supplied to the external illumination device 34.

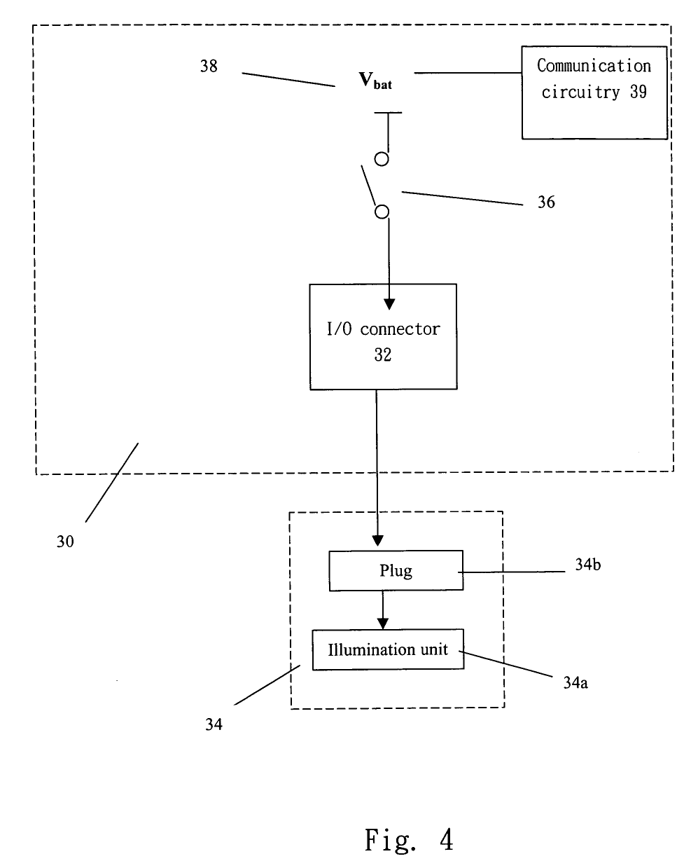

FIG. 4 is a detailed block diagram according to another preferred embodiment of the present invention. The mobile phone 30 has an I/O connector 32, an analog switch 36, a battery 38 and communication circuitry 39. The external illumination device 34 includes an illumination unit 34a and a plug 34b. By plugging the plug 34b into the I/O connector 32, the external illumination device 34 is connected to the mobile phone 30.

The battery 38 provides the electricity both for the communication circuitry 39 and the illumination device 34. The I/O connector 32 is connected in parallel to the communication circuitry 39 and controlled by the analog switch 36. When the analog switch 36 is closed, the battery 38 provides electricity to the external illumination device 34 via the I/O connector 32.

Further, by programming the circuitry of the mobile phone, the external illumination device can also be activated by the function keys on the mobile phone. For example, by pressing one or several function keys on the mobile phone, the user directly activates the external illumination device without utilizing the analog switch. This further facilitates the usage of the external illumination device.

Further, a bracket can be attached to the mobile phone so the external illumination device can be stored inside. Alternatively, a hook can be attached to the mobile phone so the external illumination device can be hung on the hook.

The present invention provides an external illumination device that a user plugs into the mobile phone to acquire a temporary light source for illumination or indication. Additionally, the external illumination device is compatible with all mobile phones having an audio jack or an I/O connector.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An external illumination device for a mobile phone, the mobile phone having an audio jack connecting to the external illumination device, the external illumination device characterized by:
the external illumination device having an illumination unit and a plug plugged into the audio jack; and
the illumination unit being illuminated by electricity supplied from a battery of the mobile phone.

2. The external illumination device of claim 1, wherein the mobile phone has an analog switch and the battery of the mobile phone supplies electricity to a pin of the audio jack by switching the analog switch to V_{bat}.

3. The external illumination device of claim 1, wherein the illumination unit is a laser diode lamp and the external illumination device functions as a laser pointer.

4. The external illumination device of claim 1, wherein the illumination unit is a light emitting diode lamp and the external illumination device functions as an illuminator.

5. The external illumination device of claim 1, wherein the mobile phone has a bracket for storing the external illumination device.

6. The external illumination device of claim 1, wherein the mobile phone has a hook whereon the external illumination hangs.

7. An external illumination device for a mobile phone, the mobile phone having an I/O connector connecting to the external illumination device, the external illumination device characterized by:
the external illumination device having an illumination unit and a plug plugged into the I/O connector; and
the illumination unit being illuminated by electricity supplied from a battery of the mobile phone.

8. The external illumination device of claim 7, wherein the mobile phone has an analog switch and the battery of the mobile phone supplies electricity to the I/O connector by switching the analog switch to V_{bat}.

9. The external illumination device of claim 7, wherein the illumination unit is a laser diode lamp and the external illumination device functions as a laser pointer.

10. The external illumination device of claim 7, wherein the illumination unit is a light emitting diode lamp and the external illumination device functions as an illuminator.

11. The external illumination device of claim 7, wherein the mobile phone has a bracket for storing the external illumination device.

12. The external illumination device of claim 7, wherein the mobile phone has a hook whereon the external illumination device hangs.
